(19) United States
(12) Patent Application Publication
(10) Pub. No.: US 2011/0086317 A1
(43) Pub. Date: Apr. 14, 2011

(54) DOUBLE-SIDED PHOTOSENSITIVE COLOR PHOTOGRAPHIC PAPER AND METHOD OF MANUFACTURING THE SAME

(75) Inventors: Feng Hou, Shanghai (CN); Zhige Yang, Shanghai (CN)

(73) Assignee: SHANGHAI CHENGSHU DIGITAL TECHNOLOGY CO., LTD., Shanghai (CN)

(21) Appl. No.: 12/999,584

(22) PCT Filed: May 25, 2009
(86) PCT No.: PCT/CN2009/071942

§ 371 Date: Dec. 16, 2010

(30) Foreign Application Priority Data
Jun. 16, 2008 (CN) 200810038976.2

(51) Int. Cl. G03C 1/775; B05D 1/36

(52) U.S. Cl. 430/538; 427/404

(57) ABSTRACT

The present invention relates to a double-sided photosensitive color photographic paper and a method for manufacturing the same. The photographic paper comprises a paper base, and a first photosensitive layer and a second photosensitive layer provided on two opposite sides of the paper base, respectively, wherein a silver shading layer is coated between the paper base and the first photosensitive layer and/or between the paper base and the second photosensitive layer. The function of the silver shading layer is to block majority of light so that light exposed to one side of the photographic paper will not expose to the photosensitive layer on the other side of the photographic paper. Therefore, undesired images on the other photosensitive layer and degradation of the original imaging quality can be avoided. Sliver in the silver shading layer can be removed during the development of the photographic paper, and the final viewing quality of the photographic paper will not be impacted.

### FIELD OF THE INVENTION

The present invention relates to photographic paper, in particular, a color photographic paper which may be double-sided photosensitive and imaged, and method for manufacturing the same.

### BACKGROUND OF THE INVENTION

The photographic paper traditionally used in photo enlarge-printing is single-sided photographic paper only one side of which is available for exposure. Imaged on one side of the photographic paper after exposure, it can be viewed from a single side in a frame or a photo album, so that the applicability of such photographic paper is limited.

Recently, a kind of double-sided photosensitive color photographic paper has been proposed, for example a utility mode application disclosed in Chinese patent publication No. CN2807300Y. Referring to FIG. 1, this photographic paper 10 comprises a paper base 11, a first photosensitive layer 12 and a first protection layer 13 provided on one side of the paper base 11, and a second photosensitive layer 14 and a second protection layer 15 provided on the other side of the paper base 11, wherein the paper base 11 is a shading layer between the first photosensitive layer 11 and the second photosensitive layer 14. Each of the photosensitive layers 12 and 14 is consisted of a red sensitive layer, a green sensitive layer and a blue sensitive layer.

The above patent intends to save photographic paper by imaging on both sides of a piece of photographic paper. However, when a piece of double-sided photosensitive photographic paper is subjected to one-sided exposure twice or is exposed on both sides simultaneously, light exposed to one side will impact the imaging quality of the other side. Although the paper base 11 can block part of light, it can not avoid majority of light casting. Referring to FIG. 2, when only the photosensitive layer 12 on one side is exposed to light, there will be part of light L1 passing through the paper base 11 and casting on the photosensitive layer 14 on the other side of the paper base, therefore the photosensitive layer 14 will be partly exposed and the subsequent imaging quality will be impacted. And on the other hand, when the photosensitive layer 14 is exposed to light, the photosensitive layer 12 will also be impacted.

Therefore, a double-sided photosensitive color photographic paper is desired to overcome the above problems in this field.

### SUMMARY OF THE INVENTION

The technical problem to be solved by the present disclosure is to provide a double-sided photosensitive color photographic paper, which can avoid the degradation of imaging quality caused by light casting when exposed to light on both sides.

This disclosure also provides a method for manufacturing a double-sided photosensitive color photographic paper.

Compared with the prior art, due to the adoption of the above technical solution, this disclosure can avoid light transmission by providing a silver shading layer, so that a undesired image will not be generated on the photosensitive layer which does not need to be exposed to light and a image with good quality can be obtained. Especially during the course of printing, the sliver in silver shading layer can be removed resulting in a transparent gelatin layer, and the final viewing quality of photographic paper will not be impacted.

### BRIEF INTRODUCTION OF THE DRAWINGS

The feature and nature of this disclosure will be further described with the following examples and drawings.

FIG. 1 is a schematic diagram of a previous double-sided photosensitive photographic paper.

FIG. 2 is a sensitogram of the photographic paper as shown in FIG. 1.

FIG. 3 is a schematic diagram of a double-sided photosensitive photographic paper according to an example of this disclosure.

FIGS. 4A and 4B are sensitograms of a double-sided photosensitive photographic paper according to an example of this disclosure.

FIG. 5 is a schematic diagram of a double-sided photosensitive photographic paper according to an example of this disclosure.

FIG. 6 is a sensitogram of a double-sided photosensitive photographic paper according to another example of this disclosure.

FIG. 7 is a flowchart for manufacturing a silver emulsion according to an example of this disclosure.

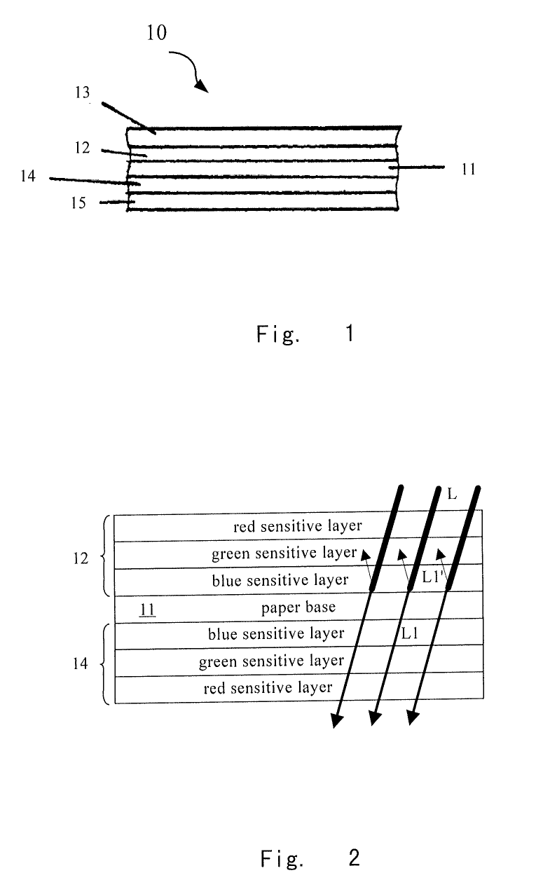

### THE PREFERRED EMBODIMENTS OF THE INVENTION

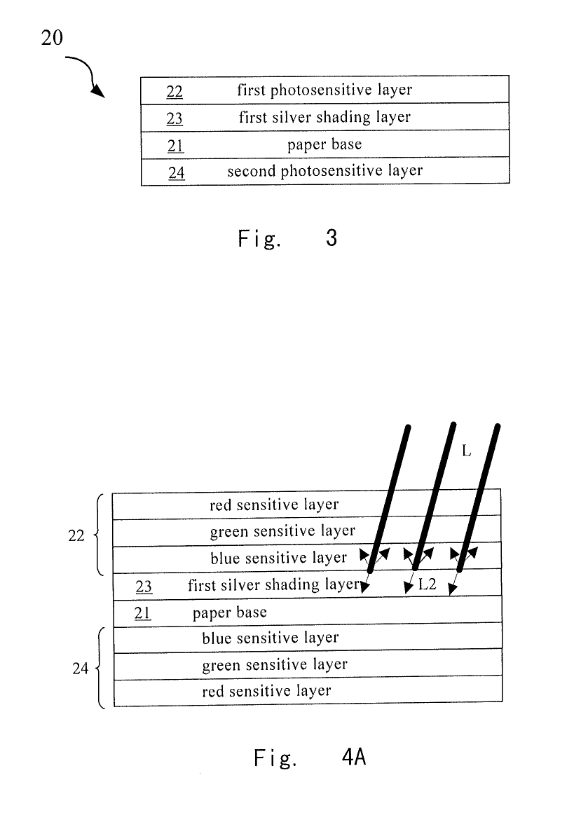

A double-sided photosensitive color photographic paper according to an example of this disclosure is used to print a picture with double-image effect at one time, and interaction during double sided exposure is guaranteed. Referring to FIG. 3, a double-sided photosensitive color photographic paper 20 of an example of this disclosure comprises a paper base 21, a first photosensitive layer 22, a first silver shading layer 23 and a second photosensitive layer 24. The first photosensitive layer 22 is provided on one side of the paper base 21 and the second photosensitive layer 24 is provided on the other side of the paper base 21. Each of the photosensitive layers 22 and 24 is further consisted of a red sensitive layer, a green sensitive layer and a blue sensitive layer, wherein the red sensitive layer, the green sensitive layer and the blue sensitive layer can be separated with separation layers, and there can be a protection layer outside the outside red sensitive layer.

The first silver shading layer 23 is provided between the paper base 21 and the first photosensitive layer 22. The first silver shading layer 23 is formed by coating a silver shading emulsion on the paper base 21, and the reflection optical density of which is controlled above 0.7 so as to prevent the light from passing through the paper base and impact the photosensitive layer on the other side of the paper base. The primary effective component of the silver shading emulsion is silver microparticles, and the solvent is, for example photographic gelatin.

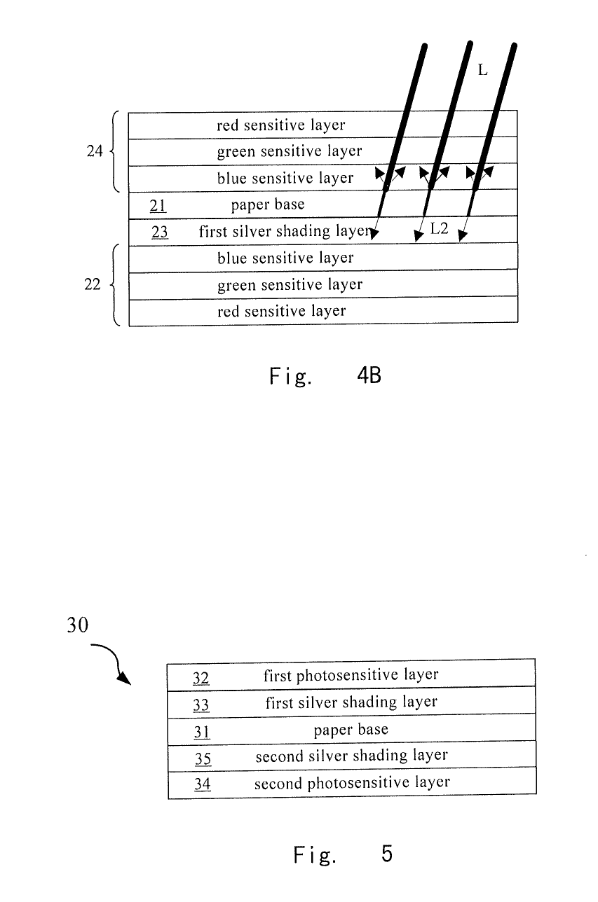

Referring to FIG. 4A, upon light L for exposing the photographic paper incidence on the first silver shading layer 23 after passing through the first photosensitive layer 22, the function of the first silver shading layer 23 is to block majority of light so that light L2 is attenuated gradually in the first silver shading layer 23 and can not pass through the paper base 21 to expose the second photosensitive layer 24 on the other side of the paper base 21, therefore avoiding an undesired image generated on the second photosensitive layer 24 by light and the degradation of the original image quality. Moreover, the first silver shading layer 23 can also reduce light reflection and diffusion L2′ within the first photosensitive layer 22 (comparing with the reflection light L1′ in FIG. 2) so as to improve the image definition of the photographic paper.

On the other hand, upon light L for exposing the photographic paper incidence on the first silver shading layer 23 after passing through the second photosensitive layer 24 and the paper base 21, the first silver shading layer 23 can attenuate light L2 gradually and the first photosensitive layer 22 will not be exposed to light.

Referring to FIG. 5, a double-sided photosensitive color photographic paper 30 according to another example of this disclosure comprises a paper base 31, a first photosensitive layer 32, a first silver shading layer 33, a second photosensitive layer 34 and a second silver shading layer 35. The first photosensitive layer 32 is provided on one side of the paper base 31. The second photosensitive layer 34 is provided on the other side of the paper base 31. Each of the photosensitive layers 32 and 34 can further be consisted of a red sensitive layer, a green sensitive layer and a blue sensitive layer.

The first silver shading layer 33 is provided between the paper base 31 and the first photosensitive layer 32. The second silver shading layer 35 is provided between the paper base 31 and the second photosensitive layer 32. The first silver shading layer 33 and the second silver shading layer 35 are formed by coating a silver shading emulsion on the paper base 21, respectively, and the reflection optical density of the first silver shading layer 33 and the second silver shading layer 35 is controlled above 0.4 so as to prevent the light to expose the photosensitive layer on the other side of the paper base. The reflection optical density of the first silver shading layer 33 and the second silver shading layer 35 can be the same or different from each other.

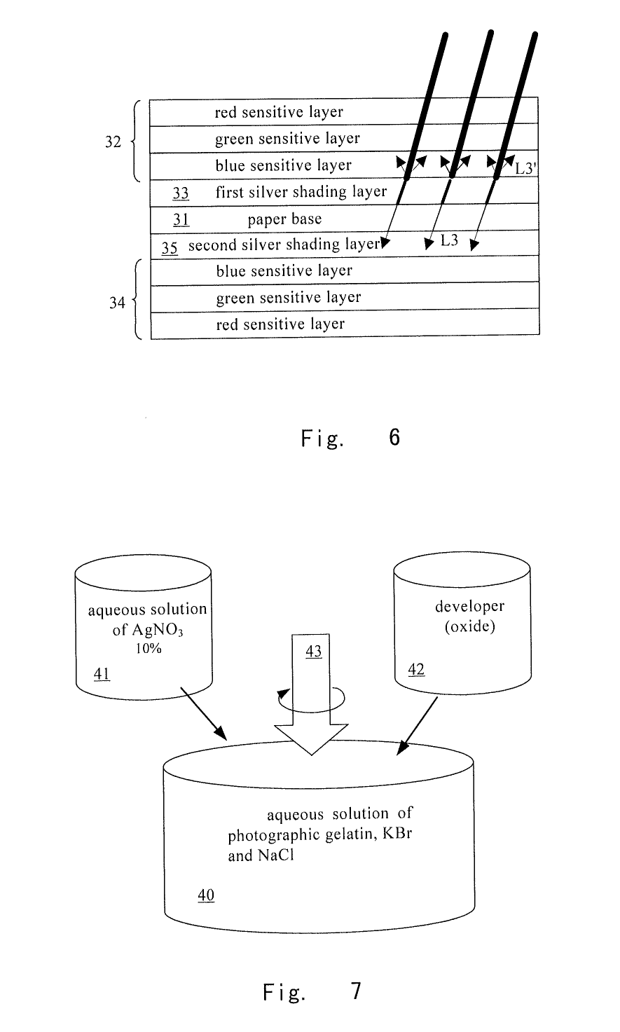

Referring to FIG. 6, upon light L for exposing the photographic paper incidence on the first silver shading layer 33 after passing through the first photosensitive layer 32, the first silver shading layer 33 and the second silver shading layer 35 can work together to block majority of light. Firstly, light is partly blocked by the first silver shading layer 33, and the residual light L3 incident on the second silver shading layer 35 after passing through the paper base 31 will be absorbed by the second silver shading layer 35 and will not expose the second photosensitive layer 24 on the other side of the paper base, therefore avoiding an undesired image generated on the second photosensitive layer 24 and the degradation of the original image quality. Moreover, the first silver shading layer 33 can also reduce light reflection and diffusion L3′ within the first photosensitive layer 32 (comparing with the reflection light L1′ in FIG. 2) so as to improve the image definition of the photographic paper.

A method for manufacturing the double-sided photosensitive photographic paper as shown in FIG. 3 is described as fellows:

Firstly, providing a paper base 21;

Secondly, coating sliver emulsion on one side of the paper base 21 to form a first silver shading layer 23, the reflection optical density of which is controlled above 0.7;

Then, coating light sensitive emulsion to the silver shading layer 23 to form a first photosensitive layer 22;

Lastly, coating the light sensitive emulsion to the other side of the paper base 31 to form a second photosensitive layer 24.

A method for manufacturing the double-sided photosensitive photographic paper as shown in FIG. 5 is described as follows:

Firstly, providing a paper base 31;

Secondly, coating sliver emulsion on one side of the paper base 31 to form a first silver shading layer 33, the reflection optical density of which is controlled above 0.4;

Then, coating light sensitive emulsion on the silver shading layer 33 to the first photosensitive layer 32;

Then, coating sliver emulsion on the other side of the paper base 31 to form a second silver shading layer 35, the reflection optical density of which is controlled above 0.4;

Lastly, coating light sensitive emulsion to the second silver shading layer 35 to form a second photosensitive layer 34 and accomplish the manufacture of a double-sided photosensitive photographic paper thereby.

Wherein, the process for manufacturing the sliver shading emulsion layer mentioned above is as follows:

The primary raw materials include sliver nitrate (AgNO₃); sodium dioxide (NaCl) and potassium bromide (KBr); developer, including hydroquinone and Motol(N-Methyl-p-aminophenol sulfate); and photographic gelatin.

Referring to FIG. 7, the process for manufacturing the same is as follows:

Firstly, a 10% aqueous solution of AgNO₃ (from a dissolving pot 41) and a developer solution (from a dissolving pot 42) of hydroquinone and Motol at 1:1 are added to a reactor 40 containing a solution with 3% photographic gelatin, NaCl and KBr periodically with fixed quantity. The mixture in the reactor 40 is stirred with an electrical motor 43 to be emulsified and aged. The reaction is as follows:

Ag⁺+Red−>Ag+OX+H³⁰

Wherein Red represents a reducer (a developer), OX is an oxide of the developer.

Then, the mixture is sediment washed to remove water-soluble materials such as byproducts (for example residual oxide, excess NaCl and KBr).

Thereafter, adding water to re-dissolve the solid material obtained,

Lastly, the product is loaded into a tube for cold storage. The obtained sliver emulsion in neutral gray is frozen-stored in a refrigerator at 5-8° C. The sliver emulsion contains Ag and photographic gelatin, possibly a little AgO.

A developing process after exposure of the above double-sided photosensitive color photographic paper (20 or 30) is as follows:

Firstly, color development: during the course of printing a double-sided photosensitive color photographic paper, Ag⁺ formed in the photosensitive layers (22 and 24, or 32 and 34) due to the exposure of the photographic paper is reduced to Ag by a color developer while Ag contained originally in the silver shading layer does not react during the color development.

Secondly, bleaching-fixed with a bleaching-fixer: during the double-sided color paper passing through the bleaching-fixer, Ag in the silver shading layer(s) (23, or 33 and 35), together with Ag and Ag⁺ in the photosensitive layers (22 and 24, or 32 and 34) react with the bleaching-fixer. The bleaching-fixer contains a bleaching agent and a fixer, wherein the metallic sliver (Ag) formed during development is converted to Ag⁺ by the bleaching agent, the reaction is as follows:

Ag+OX+H⁺−>Ag⁺+Red

Wherein OX is an oxidant and Red is the reduction product of the oxidant.

Further, the developer in the solution and silver ions (Ag⁺) are reacted to result in a soluble complex of Ag, and the developer also dissolves the undeveloped remnant silver halide (AgX) in the photographic paper, the reaction is as follows:

AgS₂O₃⁻+S₂O₃⁻²−>Ag(S₂O₃)₂⁻³

Then, washing with water to remove the remnant impurity such as the bleaching agent and complex of Ag in the emulsion layer.

After the Ag microparticles are removed, the above silver shading layer becomes a colorless transparent gelatin layer, therefore, the imaging quality of the photosensitive layer is not affected by the silver shading layer.

In conclusion, compared with the prior art, the above examples according to this disclosure have the following technical effects:

1. by providing a silver shading layer to avoid light transmission, therefore undesired images generated on the photosensitive layer and the degradation of the original imaging quality;

2. Ag in the sliver shading layer can be removed during the development of the photographic paper and thus will not affect the final viewing quality of the photographic paper.

Although this invention is disclosed above with the preferred examples, which are intended to limit the scope of this invention. Variations and modifications may be made by the skilled in the art without departing the spirit and scope of this invention. Therefore, the scope of this invention shall be as per the appended Claims.

1. A double-sided photosensitive color photographic paper, comprising:
a paper base;
a first photosensitive layer provided on one side of the paper base;
a first silver shading layer provided between the paper base and the first photosensitive layer; and
a second photosensitive layer provided on the other side of the paper base.

2. The double-sided photosensitive color photographic paper according to claim 1, further comprising a second silver shading layer provided between the paper base and the second photosensitive layer.

3. The double-sided photosensitive color photographic paper according to claim 1, wherein the reflection optical density of the first silver shading layer is above 0.7.

4. The double-sided photosensitive color photographic paper according to claim 2, wherein the reflection optical density of both of the first silver shading layer and the second silver shading layer is above 0.4.

5. The double-sided photosensitive color photographic paper according to claim 1, wherein the silver shading layer is formed by coating a sliver emulsion on the paper base, and the sliver emulsion contains at least photographic gelatin and silver.

6. A method for manufacturing a double-sided photosensitive color photographic paper, comprising:
providing a paper base;
coating a sliver emulsion on one side of the paper base to form a first silver shading layer;
coating a light sensitive emulsion on the silver shading layer to form a first photosensitive layer; and
coating the light sensitive emulsion on the other side of the paper base to form a second photosensitive layer.

7. The method for manufacturing a double-sided photosensitive color photographic paper according to claim 6, wherein prior to coating a light sensitive emulsion on the other side of the paper base to from the second photosensitive layer, further comprising:
coating the sliver emulsion to the other side of the paper base to form a second silver shading layer.

8. The method for manufacturing a double-sided photosensitive color photographic paper according to claim 6, wherein the reflection optical density of the first silver shading layer is above 0.7.

9. The method for manufacturing a double-sided photosensitive color photographic paper according to claim 7, wherein the reflection optical density of both of the first silver shading layer and the second silver shading layer is above 0.4.

10. The method for manufacturing a double-sided photosensitive color photographic paper according to claim 6, wherein the silver emulsion contains at least photographic gelatin and sliver.
